(19) United States
(12) Patent Application Publication
(10) Pub. No.: US 2007/0078963 A1
(43) Pub. Date: Apr. 5, 2007

(54) Method of remote management of the look and functionality of a website by a third party service provider with the aid of scripting technology

(76) Inventors: Scott E. Woodard, Chicago, IL (US); Sameer N. Danthurthy, Aurora, IL (US)

Correspondence Address: Jeffrey Calfa, 954 Rice Court, Naperville, IL, 60565, US

(21) Appl. No.: 11/542,783

(22) Filed: Oct. 4, 2006

Related U.S. Application Data
(60) Provisional application No. 60/723,772, filed on Oct. 5, 2005.

(51) Int. Cl. G06F 15/173

(52) U.S. Cl. 709/223

(57) ABSTRACT

A unique method allowing the external third party service provider to control the features related to a particular service on the website, taking advantage of the relationship of the website owner and the third party, and allowing dynamic status of what is to be controlled, without further modifications to the web content and without the third party needing any access to the website. The third party service provider does not need to contact the website server to dynamically determine whether or how the specific objects are to be displayed. The website owner still has fine control of the website, needs minimal additional bandwidth, and does not need to give the third party any access to its computers or website content. Additionally the client (browser) can display without delay the whole page except the third party server elements even if there is a slow response or no response from the third party server.

This patent issues from a non-provisional patent application claiming the priority of provisional patent applications Ser. No. 60/723,772, filed Oct. 5, 2005.

### BACKGROUND

The Internet today has many websites using services from external providers. The website using the service(s) puts special code on the site to show special text, icons, links, and/or other objects so an end user with a browser can use the service. The website owner has its own customers that list on the site and that may decide to use some or all of the services provided by the external providers. The problem is that a website owner may not have the resources, expertise, or incentive to maintain the changes as its customers add or remove services. The website owner may not want the additional overhead or bandwidth when providing these services. Interactive websites were previously created using Dynamic HTML, using JavaScript developed by Netscape, among others. JavaScript is a popular client-side scripting language since it is supported by both Microsoft Internet Explorer and Netscape Navigator, although there are differences in exactly how it is supported. This makes it important to test JavaScript code for cross-browser compatibility. JavaScript code may be placed within each page or in an external file called by requested pages. External modular JavaScript files may be useful for code repeated on many pages, as it potentially saves download time by programmatically inserting content into the web page. A JavaScript function is a piece of code that is defined in a program and can be invoked many times by the program. Other prior technology includes “inline frames” which are used in scripting languages and supported in most current browsers. Also in the prior technology was RSS (RDF) Site Summary. A Website that wants to “publish” some of its content, such as news headlines or stories, creates a description of the content and specifically where the content is on its site in the form of an RSS document. The publishing site then registers its RSS document with one of several existing RSS feeds from publisher(s). A user with a Web browser or a special program that can read RSS-distributed content can read periodically-provided distributions.

### SUMMARY

This invention is a unique method to allow the external third party service provider to control the features related to a particular service on the host website, that takes advantage of the relationship of the hosting website owner and the third party service provider, and allows dynamic status of what is to be controlled, without further modifications to the web content and without the third party service provider needing any access to the website. The web server does not need to contact the third party service provider for the provider to dynamically determine whether or how the specific objects are to be displayed. The website site owner still has fine control of the website, a minimal need for additional bandwidth, and does not need to give the third party service provider any access to its computers or website site content. Additionally the client (browser) can display without delay the whole page except the third party server elements even if there is a slow response or no response from the third party server.

This invention provides a solution where, once the website site owner adds non-dynamic code in specific places, third party service provider(s) can dynamically turn on or off their specific service remotely and add or change special features remotely in any or all those specific places based on up-to-date information. The website does not need to contact the third party service provider to dynamically determine whether or how the specific objects are to be displayed.

Because the third party service provider wants to provide accurate up-to-date services to another website, the third party service provider should minimally burden or rely on the primary website server's resources. This means that the provider should not require the original website to use extra server resources, require them to dynamically do decision making, require them to maintain the provider's business rules, require them to use a web service, require them to access a special database, nor require them to delay the time it takes for the client to see the website's contents.

This invention also provides a solution for the third party service provider to display its links based on its own business rules, the website owner's business rules, and the website dynamic information about an object supplied by the website and the website's customers. All the decision resources are at the third party service provider's site—the website server does not use its own computing resources to make the decision. An example in real estate is that if the status of the listing changes from “available” to “sold” by the multiple listing service website, the third party service provider should not display an icon to contact the agent to view the listing. Another parameter is the real estate agent showing the listing. This information is already used by the website when it displays the information about the listing on the page. Parameters of the listing status and agent id are embedded in the code on the downloaded page and the third party service provider uses this information as part of the decision on whether the icon is displayed, thus there is no extra database lookup, decision making, or delay at the website server.

This invention also addresses another concern that the display of the website's page at the client should not slow down due to a delay or no response by the third party service provider. This invention incorporates a solution where the page can be downloaded and displayed completely, with the third party links inserted in the proper places in the page after the page is displayed. There is essentially no increase in the bandwidth for the website, there is no need for the third party service provider to have any access to the website, and there is no need for the website owner to maintain code depending on the customer's relation with how or whether the feature is provided. Another important feature is that the website owner still has complete control on where and whether the third party service provider can provide the third party objects. This invention is very different than an RSS application where the server puts in content and links in specific places on the page based on what the client subscribes to or an e-commerce solution where an associate saves space for the advertiser to insert content and links. Placement using an RSS solution is based on prior agreement, by having the client choose ahead of time the services to be included. Until the agreement is changed the content is only what the specifically chosen providers decide to show at the moment—there is no dynamic interaction. In an e-commerce solution, again like RSS, there is space reserved for an external service. This time the website, sometimes called an associate, can decide what type of links and content is to be inserted by dynamically inserting calls to special pages of the third party service provider (advertiser), and the advertiser can decide what to insert based on the page accessed and the ID of the associate. This e-commerce solution is somewhat more dynamic but the response is only based on the page addressed and the ID of the associate, so two calls to the same page with the same ID would insert the same information. If the associate wants something different it must either use its resources to decide to choose another page address to go to or another ID. With this invention there is an added dimension of dynamic control that is very important for a relationship of a site that lists real estate properties (listings) and a third party service provider that can control its own links for each of the listings. The website owners or brokerages showing the listing may have different rules depending on the state of the listing such as status, i.e. whether it is available, under contract, or sold. In this case the website also sends dynamic parameters about the listing such as the status. Now the third party service provider uses these parameters and its resources to make the decision on whether to show or not show based on these status parameters. The website owner does not need to use its resources or take the time to make dynamic decisions. This concept can be extended for purposes other than real estate applications. Often it is the third party service provider that wants the website party to incorporate their services. To get their cooperation it is important to that there is minimal burden to the website party. This invention addresses the need to minimize any involvement in controlling the links once the process is set up.

### DRAWINGS

Other objects and advantages of the invention will become more apparent upon perusal of the detailed description thereof and upon inspection of the drawings, in which:

FIG. 1 is a block diagram showing the method and components involved in the method in accordance with the invention.

FIG. 2 is a flow diagram showing the method of this invention utilizing the components shown in FIG. 1.

FIG. 3 is sample layout of a web page created using the method of FIGS. 1 and 2.

FIG. 4 demonstrates two sets of sample results from the call to the third party service provider to fill the array of the method of FIGS. 1 and 2.

FIG. 5 is an embodiment of JavaScript sample code to control whether a link or object is displayed on a page.

FIG. 6 is an embodiment of sample JavaScript code to include additional information about an object.

FIG. 7 is a sample site utilizing the method of FIGS. 1 and 2 with two listings showing both third party objects.

FIG. 8 is a sample site utilizing the method of FIGS. 1 and 2 with third party object only on the first listing.

FIG. 9 is a sample site utilizing the method of FIGS. 1 and 2 with third party objects making suggestions about making an appointment.

FIG. 10 is an example of JavaScript modification of the code using inline frames to eliminate delay if the third party service provider is slow to respond.

### DESCRIPTION OF INVENTION

The method of this invention allows a third party service provider to dynamically control whether it displays its own links and other objects. The third party can base its decision to display the link or object on the dynamic relationship of the third party to the website, the dynamic relationship of the third party and the website's customer that the link is connected to, and the dynamic state of the content to which the link relates. The website still has complete control of its own content and has complete control of the location, look, and content of the link that the third party chooses whether to display. It makes good business sense because many times it is not convenient, practical, or easy to stay up-to-date when the owner of a website uses its own resources to decide whether to display certain links or objects on its website. The website owner can also have the option to allow the third party freedom to decide on all or some of the content of the objects or links. Also at any time the website owner can stop control by the third party service provider without any contact with the third party. The process allows for multiple links or objects, multiple third parties, and multiple listings on the page. The website owner now can provide third party services to their customers without having to maintain the services. The method allows interaction between an end user browser 101, a website 102 to be accessed by the browser 101, a primary provider or controller server(s) 103, and at least one third party service provider server 104. The browser 101 is a program local to an end user's computer. The website 102 is accessed through the primary provider or controller server(s) 103. There may be multiple third party servers 104. In the real estate application, the third party servers may be multiple listing servers (MLS), which track the availability of real estate properties. In the real estate application, the website 103 may be an aggregate service provider that displays real estate properties and real estate related services from more than one provider on the website 102. The user of the browser 101 may be a real estate buyer, seller, or agent.

When using this method, the website maintains performance, does not have the overhead of accessing web services, and uses minimal additional bandwidth. This invention includes an additional technique that allows the client page to display the website's page without additional time waiting for data from the third party service provider, if the third party site is slow, not available, or requires downloading of a large amount of information.

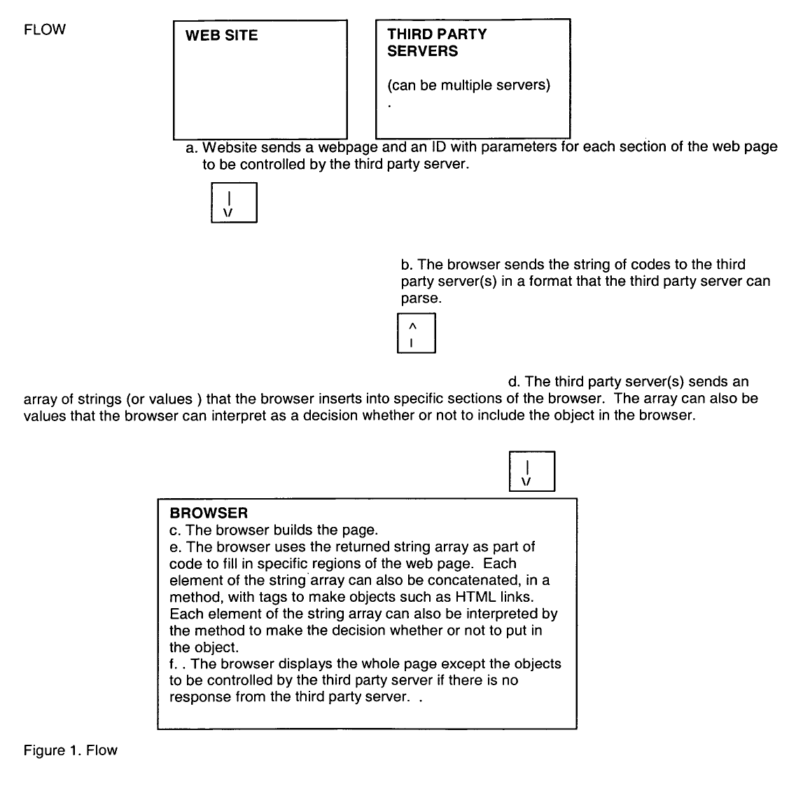

FIG. 1 describes the flow this invention uses to allow the third party service provider to control its own links. Typically when the client or browser accesses the website the client can choose a price range, a geographical area, characteristics of the house and other characteristics for which they are looking. The website then goes to its own database, sometimes supplied by an aggregator such as a multiple listing service, to generate a page to the client or browser. Generally the information in the database is maintained with current information from the brokerages representing listings. The website sends back a page of listings meeting the criteria selected. When downloading the page the website sends Listing identifiers[IDs], and dynamic parameters for each listing requested in source code format. Each listing displayed could potentially have a link to be controlled by the third party server. The IDs can include parameters that specify the web server, the listing, and other identifying states of the listing. Dynamic properties could include the status of the listing such as available or sold, the current brokerage, and the current listing agent representing the listing which can change at anytime. Generally there is an agreement and business rules shared between the website owner and the third party service provider on how to handle and interpret the dynamic parameters. See FIG. 1a. The steps may be as follows:
a. Website server sends a web page with IDs, and dynamic parameters for each section of the web page to be controlled by the third party server.
b. The browser sends the string of codes with parameters such as the website identifier, the listing id, the brokerage representing the listing, and the status of the listing to the controller server in a format that the controller server can parse. Note that parameters such as the brokerage representing the listing and the status of the listing are dynamic, and the third party service provider uses these dynamic properties as part of the decision on whether or how the object is to be displayed.
c. The browser builds the page.
d. The third party server sends an array of strings (or values) that the browser inserts into specific sections of the browser. The array can also be values that the browser can interpret as a decision whether or not to include the object in the browser.
e. The browser uses the returned string array as part of code to fill in specific regions of the web page. Each element of the string array can also be concatenated, in a method, with tags to make objects such as HTML links. Each element of the string array can also be interpreted by the method to make the decision whether or not to put in the object.
f. The browser displays the whole page except the objects to be controlled by the third party server even if there is a slow response or no response from the third party server.

As the browser renders the page, it processes the source code and decodes it as a function to send the string of IDs and parameters to the third party server. The string sent is in a format that both the third party service provider and website party have previously agreed upon (using mutually agreed standards). The specification and business rules on how to handle the data can be defined by either party or by collaboration. A relationship is important so the website party puts the information in a format that the third party service provider can parse and process with results that both parties want. See FIG. 1b. The browser continues building the page. See FIG. 1c. The third party server parses the data and uses business rules to decide whether their link for each listing should be displayed. It builds an array and sets an element of the array to 1 if it wants it displayed, and to 0 if it does not want the link related to that listing displayed. The array is sent back to the browser in source code format. It should be noted that the array elements could be characters other than 0 or 1 because it is a function in source code format sent to the browser from the website that interprets these elements. See FIG. 1d.

The browser then uses the returned string array as part of code to fill in specific regions of the web page. Each element of the string array can also be concatenated, in a method, with tags to make objects such as HTML links. Each element of the string array can also be interpreted by the method to make the decision whether or not to put in the object. The browser displays the whole page except the objects to be controlled by the third party server even if there is a slow response or no response from the third party server. See FIG. 1e.

Note that to make the decisions to display or not display the links for all the multiple listings only requires one call through the network to get the information. If there are multiple third party service providers not associated with each other, a separate call to each third party service provider may be required.

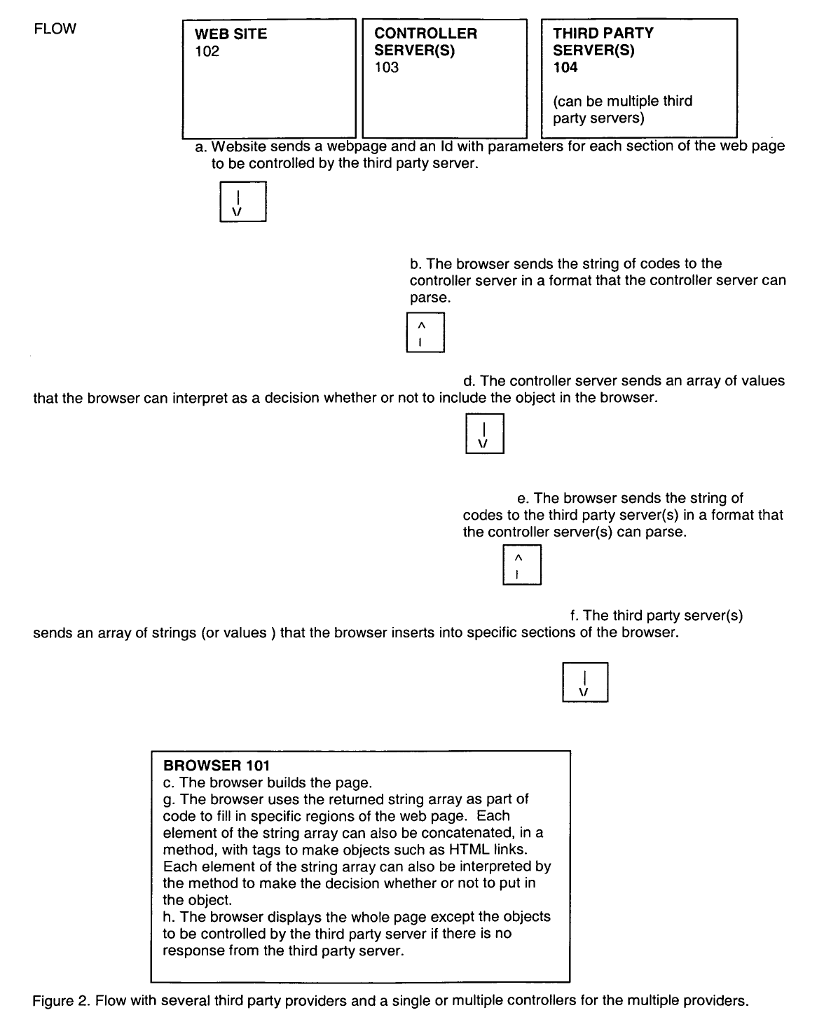

FIG. 2 shows the flow when there are multiple providers as mentioned in the previous paragraph but it is only required that there be a single controller. In this case the multiple third party service providers are supplying content to their links but one (or more) controller server(s) are deciding whether or not that the objects or links are controlled. The controller(s) could be an independent party, one of the third party service providers, or the website server itself.

The steps in FIG. 2 may be as follows:

a. Website sends a web page with IDs and dynamic parameters for each section of the web page to be controlled by the third party server.
b. The browser sends the string of codes with parameters such as the website id, the listing id, the brokerage representing the listing, and the status of the listing to the controller server in a format that the controller server can parse. Note that parameters such as the brokerage representing the listing and the status of the listing are dynamic, and the third party service provider uses these dynamic properties as part of the decision on whether or how the object is to be displayed.
c. The browser builds the page.
d. The controller server sends an array of values that the browser can interpret as a decision whether or not to include the object(s) in the browser.
e. The browser sends the string of codes to the third party server(s) in a format that the controller server(s) can parse.
f. The third party server(s) sends an array of strings (or values) that the browser inserts into specific sections of the browser.
g. The browser uses the returned string array as part of code to fill in specific regions of the web page. Each element of the string array can also be concatenated, in a method, with tags to make objects such as HTML links. Each element of the string array can also be interpreted by the method to make the decision whether or not to put in the object.
h. The browser displays the whole page except the objects to be controlled by the third party server if there is no response from the third party server.
   As in FIG. 1a the website sends a web page with IDs and dynamic parameters for each section of the web page to be controlled by the third party server. See FIG. 2a.

Almost as in FIG. 1b the browser sends the string of codes with parameters such as the website id, the listing id, the brokerage representing the listing, and the status of the listing to the controller server(s) in a format that the controller server(s) can parse. Note that parameters such as the brokerage representing the listing and the status of the listing are dynamic, and the third party service provider uses these dynamic properties as part of the decision on whether or how the object is to be displayed. The only difference between this and FIG. 1b is that the values are sent to the controller rather that the third party service provider. (Also note that one of the third party service providers or the website itself can act as the controller.) See FIG. 2b. As in FIG. 1c the browser continues to build the page. See FIG. 2c. As in 1d the controller server sends an array of values that the browser can interpret as a decision whether or not to include the object(s) in the browser. See FIG. 2d.

In FIG. 2e the browser sends the string of codes to the third party server(s) in a format that the controller server(s) can parse. The third party service providers send back array elements that are text, icons, etc. to be part of their link. See FIG. 2f. In FIG. 2g, which is similar to 1e, the browser uses the returned string array as part of code to fill in specific regions of the web page. Each element of the string array can also be concatenated or attached, in a method, with tags to make objects such as HTML links. Each element of the string array can also be interpreted by the method to make the decision whether or not to put in the object.

In FIG. 2h the browser displays the whole page except the objects to be controlled by the third party server if there is no response from a third party server, and displays the links and objects from the third party servers as they are returned to the browser.

In another configuration to get the same results, the browser would communicate only with the controller(s), and the controller(s) would communicate with each of the third party service providers to the send the results in an array of elements back to the browser. This would appear to the website and browser to be just like the flow of FIG. 1, because the controller(s) would be communicating with the third party servers behind the scene.

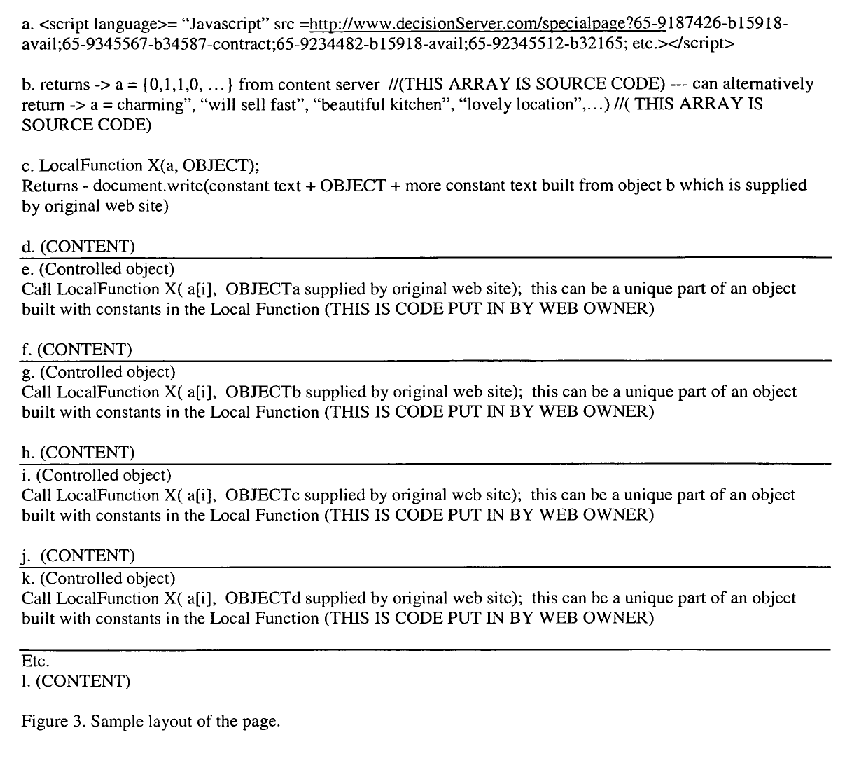

FIG. 3 is a skeleton of the layout of the page. This shows the structure of the components needed to make this method work. See FIG. 3a. This is an example of script near the top of the page is source code that tells the client or browser to send the parameters to the third party service provider at, for example, http://www.decisionServer.com/specialpage and get the results as source code. It also has parameters about four properties that the third party service provider uses to make the decisions. In this case the site has four properties that the third party service provider would provide a link. It can send more or fewer sets of parameters depending on the number of properties the third party would provide links for:
<script language>=“Javascript” src=http://www.decisionServer.com/specialpaqe?65-9187426-b15918-avail;65-9345567-b34587-contract;65-9234482-b15918-avail;65-92345512-b32165; etc.></script>

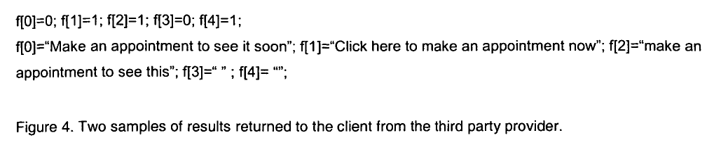

See FIG. 3b. This is information returned from the third party service provider site www.decisionServer.com. The script above says to interpret the returned information as source code and the format below is an array named “a” with four elements 0, 1, 1, and 0. Note that the array would have the number of elements equal to the number of links the third party service provider is controlling:
a={0,1,1,0};
   The returned results could be hints of text or other information to put into the link. See FIG. 4. It even can link to different icons.
   An example to insert text would be:
a={“make an appointment now”, “do not miss out, make an appointment”, “make an appointment”, “make an appointment”}.
   An example to insert icon links would be:
a={“img src=“http://site.com/icon1.gif”, “http://site.com/icon2.gif”, “http://site.com/icon1.gif”, “http://site.com/icon3.gif”}.

In FIG. 3c as the page is being rendered, a local function to be called is rendered as script code in the browser. As seen in FIG. 3e later as the page is continued to be built, two parameters are sent. When this function is called it uses the supplied element of array “a” to make the logical decision whether to write a null or to write the built link defined by the second parameter. The key is the document.write( ) function which builds the link or nothing in that spot on the page. In FIG. 3d the website continues to render contents of the page. In FIG. 3e, the website had put in source code to call the local function to build the link as the page is being displayed. As described in FIG. 3c, this source sends a specific element of the returned array related to the specific link as the first parameter, and the unique information about the link as the second parameter. These two parameters have the browser build the link at this spot in the page.

Call LocalFunction X( a[i], OBJECTc supplied by original website); this can be a unique part of an object built with constants in the Local Function 3f, g, h, l, j, k, l. The page continues to add content and links to be controlled by the third party service provider.

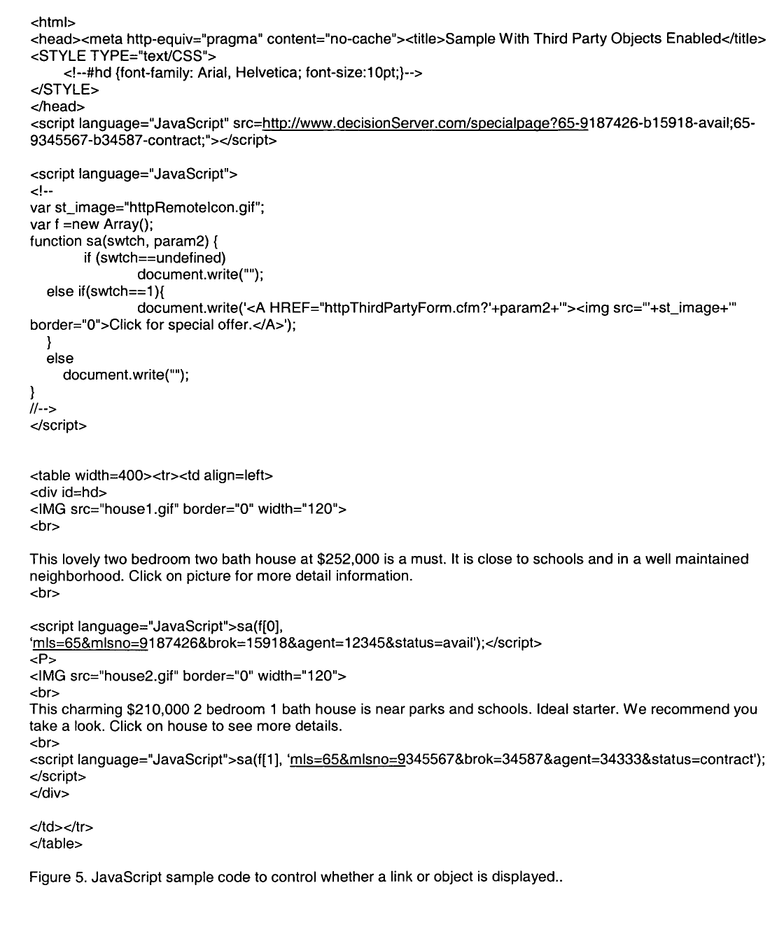

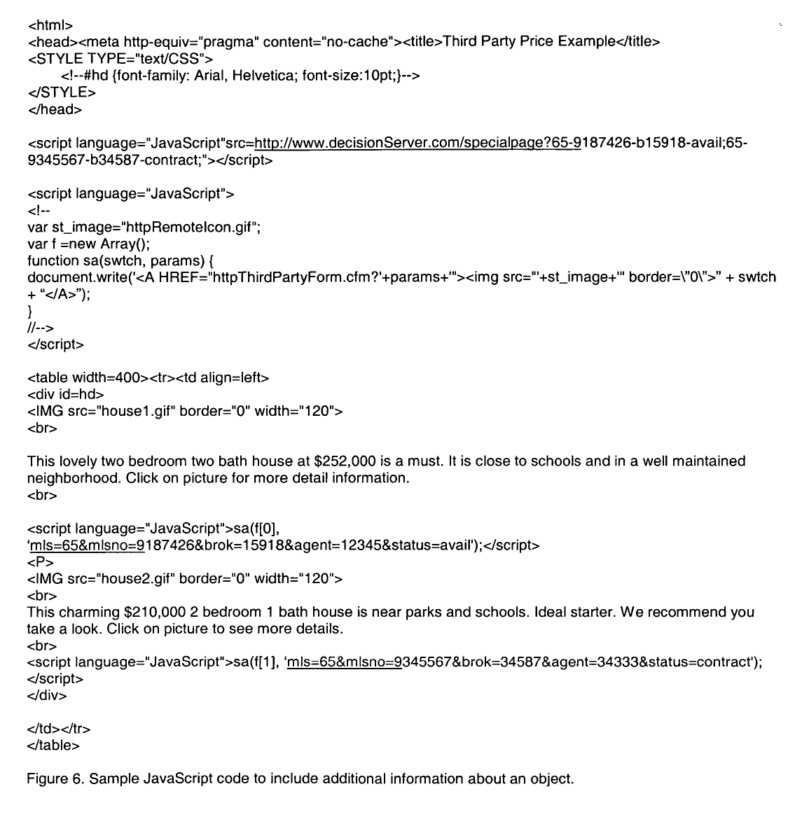

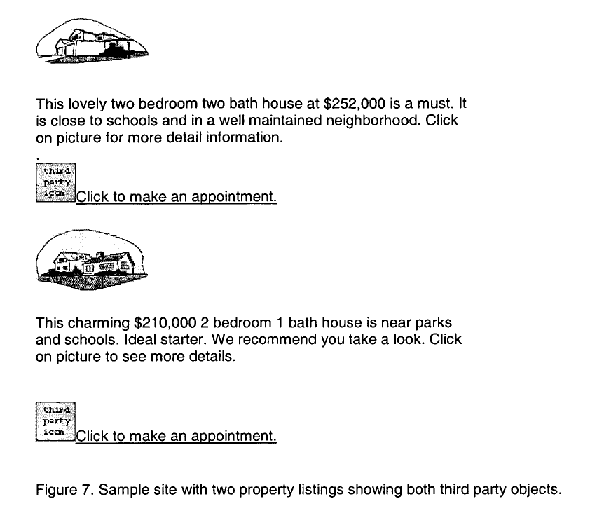

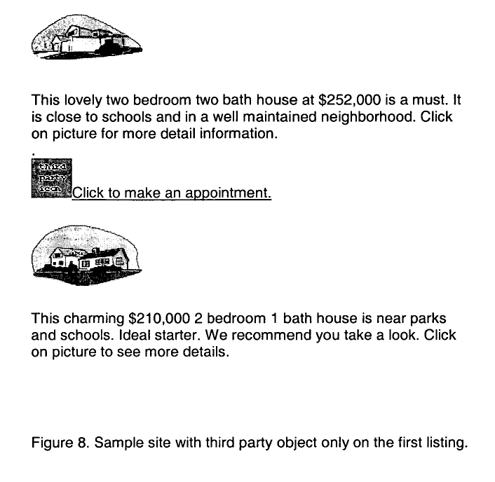

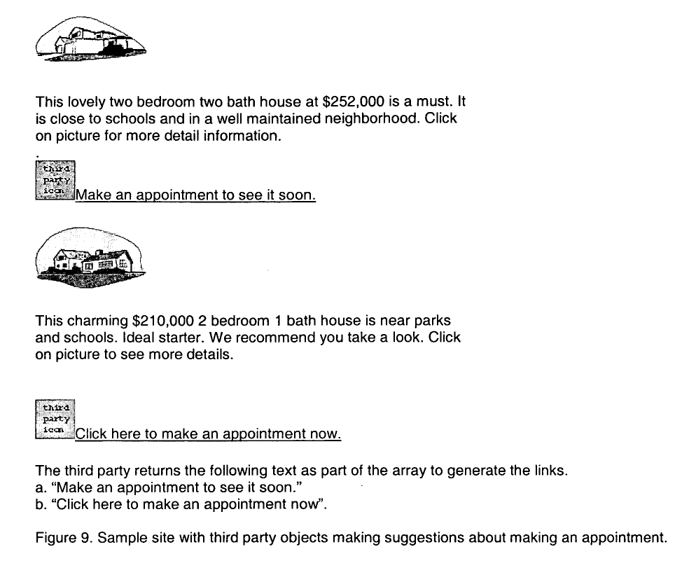

FIG. 5 and FIG. 6 are full detail examples of a page generated sent by the website. FIG. 5 is an example where the third party service provider makes the decision whether the link is displayed or not. FIG. 6 is an example where the third party service provider adds its own text to the link. FIGS. 7 and 8 are sample pages of what would be generated by FIGS. 5 depending on the array elements sent back. FIG. 9 is an example of a page generated by FIG. 6. The following are the important components of FIG. 5. The text below when rendered sends the string “65-9187426-b5918-avail;65-9345567-b34587-contract;” to the third party service provider. The third party service provider parses this string to send back the array elements.
<script language=“JavaScript” src=http://www.decisionServer.com/specialpage?65-9187426-b15918-avail ;65-9345567-b34587-contract;”></script>
The text below defines a variable st_image which stands for the remote icon. It also defines the array f which will be the array sent back by the third party server.

The most important is the local function sa. This function takes two parameters. It builds the link with the two parameters swtch which is an element of array f sent by the third party service provider, and param2, which comes from source code at the location where each link is to be controlled. In this function if the array element is undefined or not equal to the character “1” the document.write( ) function renders nothing (a null). If the array element is the character “1” then the link is built by prefexing the text ”<A HREF=“httpThirdPartyForm.cfm?” in front of the second parameter, and concatenating the text “><img src=“‘+st_image+’” border=“0”>Click for special offer.</A>38 after the second parameter. The second parameter is the unique information needed in the link supplied by the script later. When text is combined it is a complete link including the tags and is rendered by the document.write( ) function. (Note that the st_image is just the text “httpRemotelcon.gif” which is the icon for the link).

<script language=“JavaScript”>
<!--
var st_image=“httpRemoteIcon.gif”;
var f = new Array( );
function sa(swtch, param2) {
if (swtch==undefined)
document.write(“”);
else if(swtch==1){
document.write(‘<A HREF=“httpThirdPartyForm.cfm?‘+param2+’”><img
src=“‘+st_image+’” border=“0”>Click for special offer.</A>’);
}
else
document.write(“”);
}
//-->
</script>

The sets of text below are pieces of source code at each place on the page where the link is to be rendered. When the browser renders the code below it calls the function above with the element of the array corresponding to the referenced listing. (The first if f[0], the second is f[1], the third would be f[3] until f[N] for N where N is the number of listings that have links to be controlled by the third party service provider.). The text “mls=65&mlsno=9187426&brok=15918&agent=12345&status=avail” is param2 for the function above which is concatenated with a prefix and suffix to create the link and rendered at this spot by the document.writeo method of the function above.

When the browser continues rendering and gets to the second statement below it renders the next link or a null depending on the parameter f[1].

<script language=“JavaScript”>sa(f[0],
‘mls=65&mlsno=9187426&brok=15918&agent=12345&status=avail’);
</script>
<script language=“JavaScript”>sa(f[1],
‘mls=65&mlsno=9345567&brok=34587&agent=34333&status=contract’);
</script>

FIG. 7 is the output if the elements f[0]=1 and f[1]=1 were sent back by the third party service provider, both links would be displayed. The two listings of cameras both have objects that contain an icon, underlined text with code that describes that particular listing so when clicked on the site it goes to can respond to the particular listing. The third party can dynamically control whether the object shows as the page is built. In this case the third party wanted the objects to show for the both listings.

FIG.8 is the output if the elements f[0]=1 and f[1]=0 were sent back by the third party service provider, only the links with the element=1 would be displayed, therefore only the first link would be displayed. The icon and text “Click to make an appointment t” is on the page for the first listing but not for the second listing because the third party controlled whether to display each of the links. The third party dynamically controls whether the object shows as the page is built. In this case the third party only wanted the object to show for the first listing.

FIG. 6 is another example page is similar to the example page of FIG. 5 except that in FIG. 6 the third party service provider is allowed to furnish text into the link. The two main differences are that the third party service provider would return an array of text elements to include in the link rather than an array of elements 0's and 1's, and the local function now uses the array elements to add to the link. Below shows the local function of FIG. 6. If the array sent back was f[0]=“Make an appointment to see it soon” and f[2]=“Click here to make an appointment now” these would be the text of the links and the result would be like FIG. 9 where the two links say “Make an appointment to see it soon” and “Click here to make an appointment now”.

function sa(swtch, params) {
document.write(‘<A HREF=“httpThirdPartyForm.cfm?‘+params+’”><img
src=“‘+st_image+’” border=\“0\”>” + swtch + ‘</A>’);

The local function can do a final check. The website owner may want to make some final checks that the third party service provider does not distort the website's page. Many final checks can be incorporated in the local function. For example if the website wants to make sure the link descriptions are not too long it could put a clause in the local function specifying that if the text length of the array element is greater than N characters to cut it off to N characters.

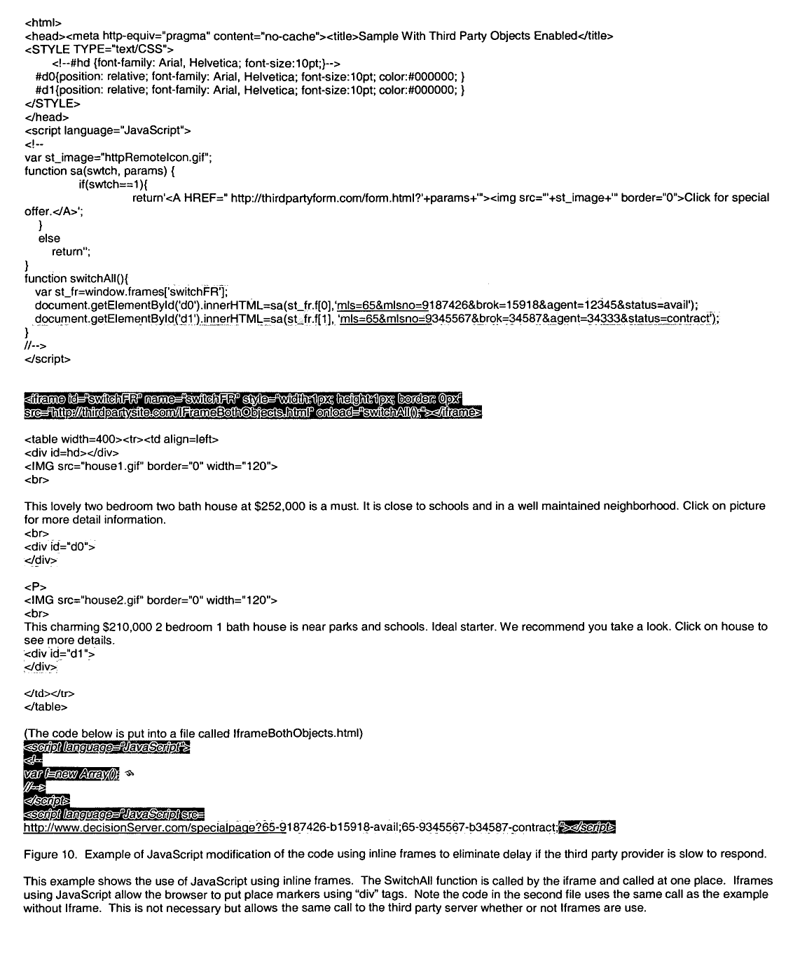

FIG. 10 is an example of these concepts combined with the technique of iframes. In many applications the performance is excellent and a technique such as iframes is not needed. There are instances that if the third party controller has a slow response or there are some connection difficulties the display of the website page could be delayed. Iframes assure that the page is rendered without delay and the links that are to be displayed are rendered afterward into the correct designated places. Iframes label the locations of each link in the page and allow the labeled locations to be rendered after the rest of the page is rendered. This guarantees that the page is rendered immediately whether or not the third party service provider responds slowly or not at all. The links then can be inserted and rendered as the response from the third party is received.

This section explains the more general aspects of this invention. It should be noted that when the previous sections mention JavaScript, they could be substituted to other scripts such as VB script and other languages that can reside and run in a client. When a browser is mentioned, it could be substituted by a client, a smart client, or anything that displays information sent to it. When the Internet is mentioned it could be substituted by a network or any median that information can travel through. When a link is mentioned it can be a more complicated web object that can reside in a browser or a client. The technique of iframes can be substituted with any concept of specified locations in a client that can be rendered asynchronously with the rest of the text of the client. This can be extended from a real estate application to any application where a third party wants to control its links.

As described above, the method of remote management of the look and functionality of a website by a third party service provider with the aid of scripting technology of this invention provide a number of advantages, some of which have been described above and others of which are inherent in the invention. Also modifications may be proposed to the method of remote management of the look and functionality of a website by a third party service provider with the aid of scripting technology without departing from the teachings herein.

We claim:

1. A method of remote management of the look and functionality of a web page by a third party service provider with the aid of scripting technology, the method involving an end user browser, a website to be accessed by the browser and at least one third party server, the browser being a preexisting program local to an end user's computer, comprising the steps of:
sending a web page from the website to the browser with an identifier with parameters for each section of the web page to be controlled by the third party server;
sending a string of codes to the third party server from the browser in a format that the third party server can parse;
building a web page for display by the browser;
sending an array of strings or values from a third party server that the browser can interpret as a decision whether to display a specific object in the web page created by the browser;
sending a string of codes from the browser to the third party server in a format that the third party server can parse;
sending an array of strings or values from the third party server to the browser that directs the browser to provide inserts into specific sections of the web page created by the browser;
using the returned string array from the third party server by the browser as part of the code to fill in specific regions of the web page, each element of the string from the third party server being concatenated in a method with tags to make objects or links, each element of the string array from the third party server being interpretable to make a decision whether to include and display the objects; and
displaying of the whole page by the browser except the objects controlled by the third party servers if no response received from the third party server.

2. The method of claim 1, wherein there are more than one third party servers each providing content to be controlled by the website server and displayed on the web page by the browser.

3. The method of claim 2, wherein the website server can exactly define the look and content of the objects or links dynamically controlled by the third party servers, allowing the third party servers to insert some content through the method.

4. A method of remote management of the look and functionality of a website by a third party service provider of the availability and status of real estate listing services for buyers, sellers, and agents with the aid of scripting technology, the method involving an end user browser on a system accessible by a real estate buyer, seller, or agent, a website to be accessed by the browser, and at least one third party server, comprising the steps of:
sending a web page from the aggregate real estate service provider website to the browser of the end user looking for real estate with an identifier with parameters for each section of the web page to be controlled by the third party server;
sending a string of codes to the third party server from the browser in a format that the third party server can parse, the string of codes requesting the third party server identify which objects representing real estate listings can be displayed on the web page;
building a web page for display by the browser;
sending an array of strings or values from the third party server that the browser can interpret as a decision whether to display a specific object representing a real estate listing in the web page created by the browser;
sending a string of codes from the browser to the third party server in a format that the third party server can parse, the string of codes representing a call from the browser as to status of the listings included in the web page;
sending an array of strings or values from the third party server to the browser that inserts the status into specific sections of the web page created by the browser;
using the returned string array from the third party server by the browser as part of the code to fill in specific regions of the web page, each element of the string from the third party server being concatenated in a method with tags to make objects or links to each real estate listing, specified by each element of the string array from the third party server being interpretable to make a decision whether to include and display status of the objects representing real estate listing; and
displaying of the whole page by the browser as directed by string of code array instructions from the third party servers.

5. The method of claim 4, wherein there are multiple third parties each providing content to be controlled by the aggregate real estate service website server and displayed on the web page by the browser.

6. The method of claim 5, wherein the aggregate real estate service website server can define the look and source of the objects and links, while the behavior is dynamically controlled by the third party servers.

7. The method of claim 6, wherein multiple third parties control links or objects on the web page created by the browser with the aggregate real estate service website server defining the overall look and feel of the resulting web page.

8. An improved method of remote management of the look and functionality of a web site by a third party service provider of the availability and status of real estate listing services for buyers, sellers, and agents with the aid of scripting technology, the method involving an end user browser on a system accessible by a real estate buyer, seller or agent, a website to be accessed by the browser, a primary provider of an aggregate of real estate properties and services, and at least one third party server, the improvement being the control of the display of availability and status of real estate properties by third party service providers through the primary website and the primary website defining the overall look and feel of the resulting web page created by the browser.

9. An improved method of remote management of the look and functionality of a web site by a third party on the availability and status real estate listing services for buyers, sellers, and agents with the aid of scripting technology, the method involving an end user browser on a system accessible by a real estate buyer, seller or agent, a website to be accessed by the browser, a primary provider of an aggregate of real estate properties and services, and at least one third party server operated to control each listing, the improvement being the browser sending the string of codes to the third party server in a format that the controller server(s) can parse upon initial loading from the website, the third party server sending an array of strings that the browser inserts into specific sections of the browser, and the browser using the returned string array as part of code to fill in specific regions of the web page, each element of the string array being capable of being concatenated with tags to make objects, each element of the string array can also be interpreted by the browser to make the decision whether or not to put in the object in the displayed web page.

10. The method of claim 7, wherein multiple third party service providers provide input to control the look and feel of the web page created by the browser.
